(19) United States
(12) Patent Application Publication
(10) Pub. No.: US 2010/0033003 A1
(43) Pub. Date: Feb. 11, 2010

(54) SIT/STAND SUPPORT FOR A VEHICLE

(76) Inventors: Mikael Sandberg, Goteborg (SE); Gustav Sand, Jarlasa (SE)

Correspondence Address: VOLVO TECHNOLOGY OF AMERICA, CORPORATE PATENTS, 7825 NATIONAL SERVICE ROAD, MAIL STOP, AP1/3-41, GREENSBORO, NC, 27409, US

(21) Appl. No.: 12/310,511

(22) PCT Filed: Sep. 1, 2006
(86) PCT No.: PCT/US2006/034388

§ 371 Date: Jul. 6, 2009

(51) Int. Cl. B60N 2/24; B60N 2/44; B60N 2/10; B60N 2/06; B60N 2/12; B60N 2/22

(52) U.S. Cl. 297/325; 297/452.24; 297/344.1; 297/383; 297/353

(57) ABSTRACT

A support apparatus for the operator of a vehicle for sitting, semi-sitting, or leaning, includes a seat support mounted on a base, the seat support having a compound convex curvature on an upper surface defining a rear sitting portion, a central semi-sitting portion and a forward leaning portion, and a horn projecting from the central portion to provide lateral support and vertical support to the operator.

### FIELD OF THE INVENTION

The invention relates to operator-supporting apparatuses for vehicles, more specifically, an apparatus for supporting an operator in sitting or standing positions in a vehicle.

### BACKGROUND

In many vehicles, the operator may find it convenient to sit or stand, or change from sitting to standing, during the course of operating the vehicle. For example, U.S. Pat. Nos. 2,565,666 and 3,076,517 disclose delivery trucks with chairs that support the driver in a seated driving position and which can be collapsed and moved forward to an “out-of-the-way” position to allow the driver to operate the vehicle in a standing position. In each of the above patents, the seat is moved to an inoperative position, i.e., a position where it does not support the driver, to permit standing operation of the vehicle.

U.S. Pat. No. 4,787,675 to McLeod discloses a chair for a boat in which the seat portion can be oriented for a fully seated position (weight on the legs and buttocks) or a half-seated position (weight distributed between legs, buttocks and feet), or folded out of the way to allow standing.

U.S. Pat. No. 5,364,151 to Yurasits, which is owned in common with the present invention, discloses a chair for a utility vehicle having a back and seat portion that can be oriented for sitting or pivoted to provided a substantially vertical surface which the operator can lean back against while standing.

The ability to change between sitting and standing is desirable for operators of utility trucks. Utility trucks, for example, delivery, refuse and recycling trucks, are operated on duty cycles that include frequent stops and starts with the driver and other workers exiting the truck cab at a stop to perform tasks and re-entering the cab to travel to the next stop. Recycling trucks have been found to make nearly one thousand stops per shift, and rear-loading refuse trucks were found to make close to eight hundred stops in a shift. These operators may wish to stand while operating the truck to facilitate exiting the cab when stops are close in time, or may wish to sit when there is longer time between stops.

Adaptations have been made to assist the driver and other worker. The trucks are typically designed as cab-over-engine, cab forward architecture, meaning the operator's cab is positioned over and in front of the engine. This allows the cab to be positioned relatively low to the ground, which also allows the lowest step to be close to the ground.

Also, refuse collection trucks are made with dual controls, that is, the truck has controls, steering wheel, accelerator pedal, brake pedal, and loader controls, on both the left and right hand sides. This allows an operator to work from the curb side of the street to improve efficiency and reduce work load of the operator.

### SUMMARY

The invention provides a support apparatus for a vehicle for sitting, half-sitting, or standing support as desired by the operator without adjustment of the support apparatus.

The invention provides a supporting apparatus having a seat support and back support mounted to a bracket assembly. The bracket assembly allows the apparatus to be moved relative to an operator's station to adjust for the operator's height and arm length.

The bracket assembly further allows the seat support angle to be adjusted relative to horizontal to the operator's preference.

The seat support includes a surface curved convexly in the longitudinal direction and curved concavely in the lateral direction to provide support for sitting, half-sitting, and standing without adjustment of the seat position. The operator need only slide or move on the seat support to position herself in a selected one of the three positions.

The seat support further includes a horn located centrally on the seat support that provides lateral support to resist sideward movements of the vehicle and some vertical support to prevent sliding downward.

### BRIEF DESCRIPTION OF THE DRAWINGS

FIG. 1 is a diagrammatic cut-away view of an interior of a utility truck cab showing an operator support in accordance with the invention mounted on a right hand drive position;

FIG. 2 is a side view of the operator support of FIG. 1;

FIG. 3 is a schematic diagram showing exemplary relative dimensions and angular orientation of the seat support of the invention;

FIG. 4 is a diagram of a seat support showing a pressure distribution for a seated operator;

FIG. 5 is a schematic view of an operator seated on the support of the invention;

FIG. 6 is a diagram of a seat support showing a pressure distribution for a half seated, half standing operator;

FIG. 7 is a schematic representation of an operator half seated and half standing using the support of the invention;

FIG. 8 is a diagram of a seat support showing a pressure distribution for a standing and leaning operator;

FIG. 9 is a schematic representation of an operator standing and leaning against a support in accordance with the invention; and

FIG. 10 is a rear view of a support in accordance with the invention to illustrate the bracket assembly.

### DETAILED DESCRIPTION

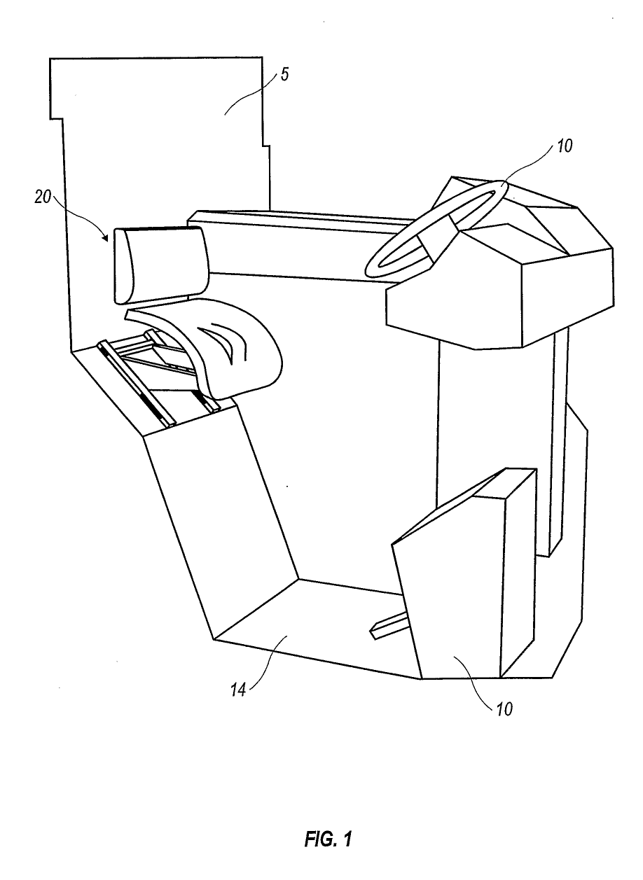

FIG. 1 illustrates an operator support apparatus 20 in accordance with the invention in an exemplary application. The figure is a diagrammatic view of an interior of a truck cab showing a right hand drive position for a utility truck, such as refuse collection truck. An operator support 20 in accordance with the invention is mounted to a back wall 5 of the cab on a bracket assembly 40. A steering wheel 10 and foot rest 12 are at the front portion of the cab. The apparatus 20 according to the invention is not limited to trucks, but could also be used in other vehicles where an operator may find it advantageous to change positions from sitting to leaning or standing. For example, the support apparatus could be used in a boat, city bus, or a subway train or trolley.

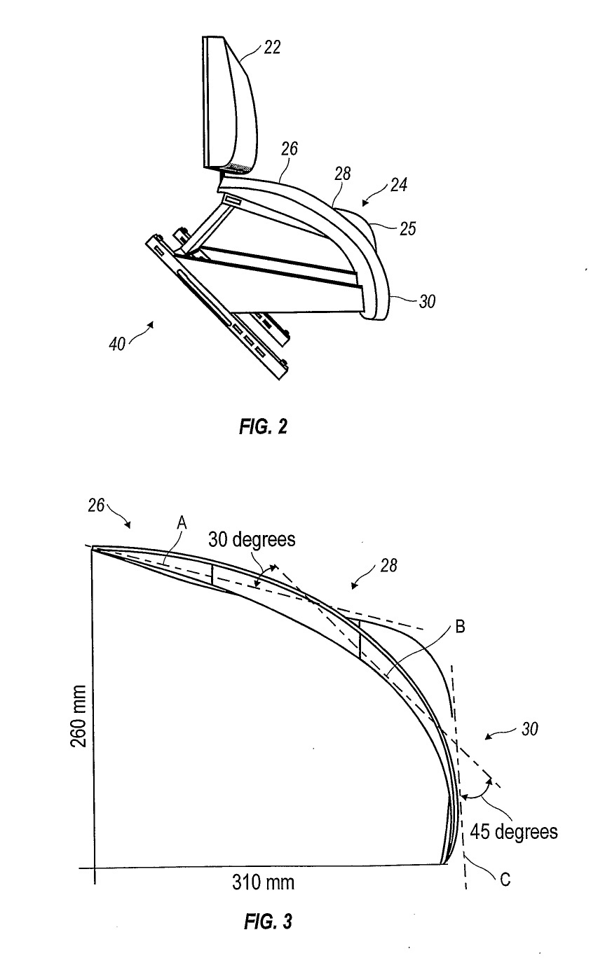

FIG. 2 is a side view of the operator support 20. As mentioned, a base 40 mounts the support 20 to an interior wall or surface of a truck cab in this exemplary embodiment. The support apparatus 20 comprises a seat support 24 and a back support 22. The back support 22 is mounted at a substantially vertical orientation at a rear of the seat support 24. The seat support 24 provides support structure for the buttocks, sit bones, and thighs of the user in different proportion depending on the user's position. For sitting, the users weight is supported primarily by the sit bones area, the buttocks and upper thighs. In sitting, little or no weight is supported by the feet. For leaning, the user's weight is predominately supported by the feet, with a small amount supported by the buttocks and thighs leaning against the support. In semi-sitting, or half-sitting, the user's weight is supported by the sit bones area and the feet in a proportion between sitting and leaning. The exact distribution depends on how the user positions himself on the seat support, so precision is not possible in a definition. It is possible in semi-sitting to have the user's weight supported in equal proportion by the sit bones area and the feet, which is not possible in either sitting or leaning.

Both the back support 22 and seat support 24 may be appropriately cushioned and upholstered for comfort and aesthetics. In some installations, however, it may not be necessary or desired to include cushioning or upholstery, and the back support and seat support may be provided as shells.

The seat support 24 is shaped on its upper surface with a compound convex curvature in the longitudinal direction (front to back), which is left to right in FIG. 2, and a convex curvature in the lateral direction (side to side). The curvature provides three areas on the seat support 24: a rear portion 26 for sitting; a center portion 28 for half-sitting; and a front portion 30 for leaning support. This compound curvature provides the user with support regardless of whether standing, leaning or sitting, without the need of adjusting the seat to accommodate the different positions, as will be explained in more detail below.

A horn 25 is formed as a rounded protuberance in the central portion 28 of the seat support 24. The horn 25 is relatively narrow in the lateral direction to facilitate it being straddled by the user and is relatively long in the longitudinal direction to provide lateral support to the legs over a long area to avoid pressure points. The horn 25 has a peak somewhat forward of the center of the seat support 24.

FIG. 3 is a schematic view of the seat support 24 showing in side view the relative orientation of functional surfaces formed by the compound convex longitudinal curvature according to a preferred embodiment of the invention. As may be seen, the seat support 24 is relative flat in the rear portion 26 having a relatively large radius of curvature, decreases in radius of curvature to become more rounded in the center portion 28, and has the smallest radius of curvature in the front portion 30. The lines A, B, and C represent an exemplary relative average angular orientation of, respectively, the rear portion 26, central portion 28, and front portion 30 of the seat support 24. As shown in this example, the average orientation between the rear 26 and central 28 portions is about a 30 degree angle, and an average orientation between the central portion 28 and the front 30 portion is about a 45 degree angle. Thus, in this example, the rear portion 26 and front portion 30 are at about a 105 degree angle, or approximately perpendicular. These relative angles are provided for the purposes of illustration. The orientation of the rear portion 26 to the central portion 28 can range from about 15 degrees to about 45 degrees. The orientation of the central portion 28 to the front portion 30 can range from about 25 degrees to about 60 degrees.

The exemplary seat support 24 has a length of about 310 mm and a height of about 260 mm. The seat support is about 460 mm wide in this example. The exemplary dimensions provide seat support 24 have a size convenient for use by a users over a wide size range, as is further described below. Of course, these dimensions can be varied to suit a particular situation.

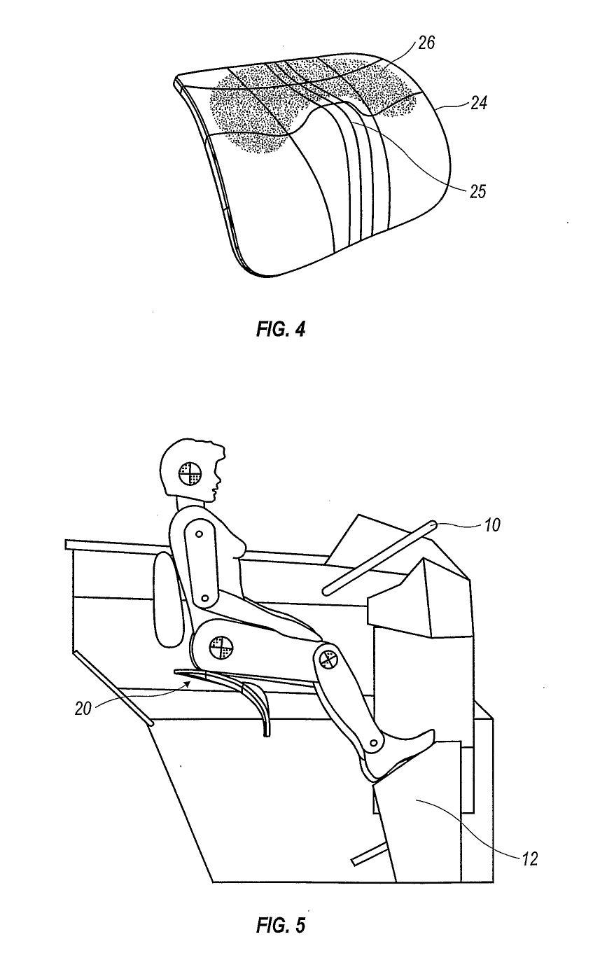

The rear portion 26 extends rearwardly from the horn 25 and is relatively flat longitudinally with a small lateral concave curvature for lateral support for sitting. As illustrated in FIG. 4, a pressure distribution for sitting is shown by the gray shading. As described below, the seat support 24 may be oriented so that the rear portion 26 is more or less horizontal, depending on the user's preference. The rear portion 26 is configured to support the seat bones (ischial tuberosities) area, typically referred to as the buttocks, and the upper thighs. This surface works more as a conventional seat when the user rides as a passenger, as illustrated in FIG. 5.

FIG. 5 illustrates an operator corresponding in height to a female of the 5^{th} percentile height (approximately 150 cm or 59 inches) in a seated position with feet on the foot rest 12. As discussed below, the support of the invention is adaptable to users of a range of height and size.

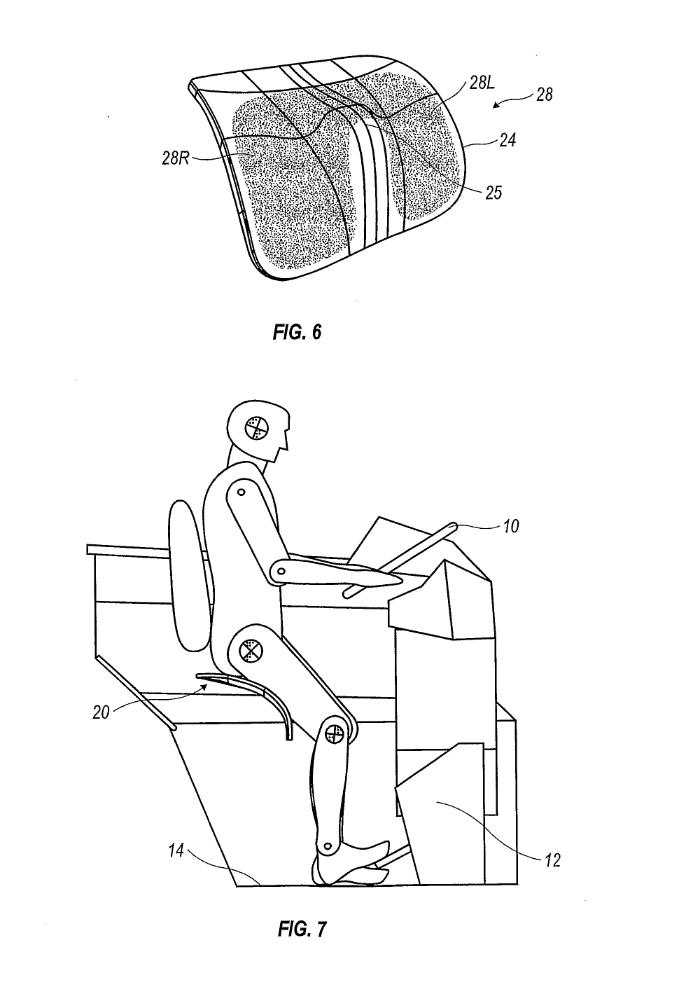

The central portion 28 has a greater radius of curvature than the rear portion 26, and is intended to support an operator in a half sitting/half standing or semi-sitting position. FIG. 6 shows a pressure distribution on the central portion 28 of the seat support and FIG. 7 shows schematically an operator in the half seated/half standing position. As may be understood, the central portion 28 of the seat support provides support for the buttocks and upper thighs while part of the user's weight is supported by the user's feet. The two surfaces 28L and 28R on either side of the horn, intended to support the thighs, have a radius of curvature in the lateral direction for supporting the thighs. Thus, the more pressure the user puts on the seat by leaning/sitting the bigger is the surface that the pressure is distributed over. If the user leans/stands the pressure is lower and he needs a smaller area of support (a too big surface will be an obstacle during rising up from the seat and egress). If the user is semi-sitting he puts more of his weight on the seat and needs a bigger area in order to avoid local pressure peaks.

The horn 25 helps to prevent the user from sliding downward. With the horn 25, the lateral curvature of the central portion 28 provides a contour complementary to the human body, that is, for support of the buttocks and upper thighs. This contour provides the driver with enhanced lateral support, which means less strain on the legs when the driver is keeping the balance while driving. In addition this curvature also provides the driver with vertical support and prevents him or her from sliding down from the seat.

The operator illustrated in FIG. 7 corresponds to a male of the 95^{th} percentile height (approximately 185 cm or 73 inches), which helps show the adaptability of the apparatus to different height operators.

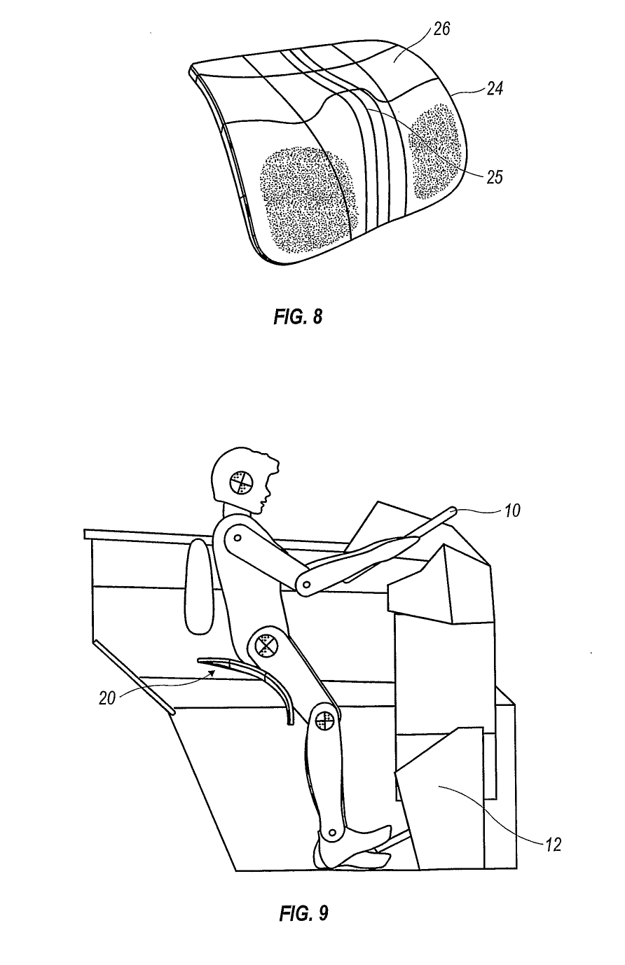

Referring now to FIG. 8, the front portion 30 extends in a forward direction from the central portion 28 and as a result of curvature depends downwardly at its front extreme in a vertical or nearly vertical orientation. The front portion 30 is intended to support the upper thighs of an operator in a standing and leaning position. This position is useful, for example, when the driver needs best possible visibility, or when there is little driving time between stops. In this position, the operator leans back against the support as shown in the pressure distribution diagram of FIG. 8 and the schematic of an operator in FIG. 9. Since this is the active surface in the standup position (with very frequent ingress/egress cycles) it has very little lateral curvature, which facilitates the ingress/egress. Note also that the upper surface of the horn 25 has merged with the surface of the front portion 30, as may also be seen in FIG. 2. The operator in FIG. 9 represents the same size operator as shown in FIG. 5.

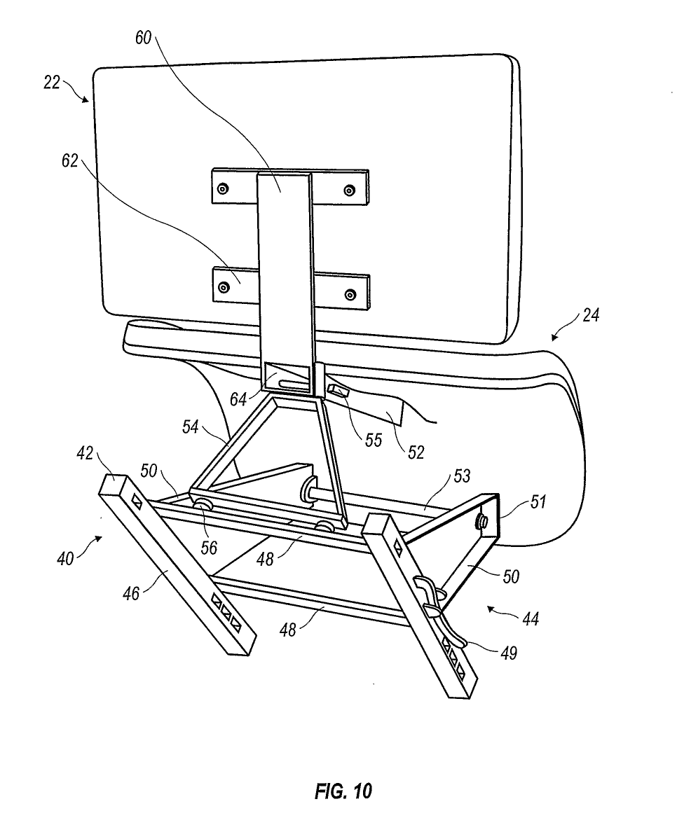

Turning now to FIG. 10, the seat support is mounted to the vehicle by a base 40. The base 40 includes two rails 42 that are fastened to the rear wall 5 of the vehicle in the illustrated embodiment. In other vehicles, the rails would be fastened to an appropriate supporting surface or structure. A sliding frame 44 is mounted on the rails 42 for adjusting movement along the length of the rails. The sliding frame 44 includes two U-channel members 46 connected by cross bars 48. A hole and pin arrangement 49 may conveniently be used to provide the fastening means. Legs 50 are attached to each of the U-channel members 46 and extend forward to connect to the front portion 30 of the seat support. The sliding frame 44 may be fastened at a selected location on the rails 42. When the rails 42 are mounted to an angled or vertical surface, as may be seen in FIG. 2, this allows the height of the seat support to be adjusted. By comparing FIGS. 5 and 7, one gains an appreciation for the height adjustment feature of the bracket assembly. The legs 50 are pivotally attached to the front portion 30 of the seat support 24 by a pair of brackets 51 attached to the front portion 30 and a pivot shaft 53.

The base 40 also includes a seat bar 52 that supports the rear portion 26 of the seat and the back support 22. The seat bar 52 is a channel shaped member that is attached to a lower surface of the seat portion and extends longitudinally from the rear portion 26 to the center portion 28. A seat brace 54, shown here as a trapezoidally shaped member, supports the seat bar 52 on the frame 44. The seat brace is releasably fastened to the seat bar 52 by an adjustment mechanism 55 that allows the seat brace to be secured at a selected point on the seat bar. The seat brace 54 is also pivotally fastened to one of the cross bars 48 by rocking pins and dampers 56, which allow pivoting movement of the seat brace relative to the cross bar 48. In the illustrated embodiment, the adjustment mechanism 55 is a hole and pin arrangement. By changing the mounting position of the seat brace 54, the seat support 24 may pivot on the legs 50 to change the angular orientation of the seat support to provide a more or less horizontal rear portion seating surface. The seating surface can tilt to the rear, be substantially horizontal, or tilt toward the front, as desired by the operator.

The back support 22 includes a post 60 fastened at an upper portion 62 to a rear surface of the back support and extending downwardly. The post 60 has a lower end portion 64 bent at an angle to the upper portion. The lower end portion 64 is received in a channel in the seat bar 52 and is clamped or otherwise mounted thereto. The clamping or mounting means allows the lower end portion to be moved and positioned longitudinally relative to the seat bar 52 to provide spacing adjustment for the back support 22. The post 60 may also include a height adjustment bracket 62 that allows the height of the back support 22 to be adjusted relative to the seat support 24. The adjustments accommodate operators of different size.

As disclosed here, an operator support allows the operator to change from a standing and leaning position to a half-seated position to a seated position without changing or adjusting the seat. This provides convenience and function not known in the art.

The operator support of the invention has been described in conjunction with a utility vehicle, but this is for the purposes of description and illustration and the invention is not limited thereto. The invention can provide an operator support for a marine vessel, an industrial or agricultural vehicle, or even a stationary work station. Those skilled in the art will understand that the invention as described here can be adapted without departing from the scope of the appended claims.

1. An apparatus to support sitting, semi-sitting, and leaning, comprising:
a base;
a seat support mounted on the base, the seat support comprising a shell having a compound longitudinal curvature convex on an upper surface defining a rearward sitting portion, a central semi-sitting portion, and a forward leaning portion, the central portion and forward portion having smaller radiuses of curvature than the rearward portion, and having a horn projecting upwardly from a center of the central portion.

2. The apparatus of claim 1, wherein the rearward sitting portion has a concave lateral curvature on an upper surface.

3. The apparatus of claim 1, wherein the horn divides the central portion into left and right thigh support areas.

4. The apparatus of claim 3, wherein the thigh support areas each have an upwardly concave lateral curvature.

5. The apparatus of claim 1, wherein the forward portion has a radius of curvature smaller than the radius of curvature of the central portion.

6. The apparatus of claim 1, wherein the horn has a longitudinal extent greater than a lateral extent.

7. The apparatus of claim 1, wherein the base comprises a pair of legs pivotally supporting a forward end of the seat support and a seat brace selectively movably supporting a rear end of the seat support wherein an angular orientation of the seat support relative to horizontal is adjustable.

8. The apparatus of claim 1, wherein the base comprises legs attached to the seat support and a frame mountable to a surface, the legs being movably mounted to the frame for positioning the seat support at a selected location along the frame.

9. The apparatus of claim 1, further comprising a back support mounted at the rear of the seat support.

10. The apparatus of claim 9, wherein the back support is movably mounted to the seat support for relative horizontal adjustment.

11. The apparatus of claim 9, wherein the back support is movably mounted to the seat support for relative vertical adjustment.

12. An operator support for a vehicle for sitting, standing or semi-sitting, comprising:
a seat support comprising a shell having a compound longitudinal curvature convex on an upper surface defining a rearward sitting portion, a central semi-sitting portion, and a forward leaning portion, the central portion and forward portion having smaller radiuses of curvature than the rearward portion, and having a horn projecting upwardly from a center of the central portion;
a pair of legs pivotally supporting a forward end of the seat support and a seat brace selectively movably supporting a rear end of the seat support wherein an angular orientation of the seat support relative to horizontal is adjustable; and,
a frame supporting the legs and seat brace.

13. The operator support of claim 12, further comprising a back support mounted at a rear end of the seat support.

14. The operator support of claim 12, wherein the legs are movably mounted to the frame to allow adjustment of the position of the legs on the frame.

15. The apparatus of claim 1, wherein a plane defining the rearward sitting portion is at an angle of about 15 degrees to 45 degrees relative to a plane defining the central semi-sitting portion, and the plane defining the central semi-sitting portion is at an angle of about 25 to 60 degrees relative to a plane defining the forward leaning portion.

16. The operator support of claim 12, wherein a plane defining the rearward sitting portion is at an angle of about 15 degrees to 45 degrees relative to a plane defining the central semi-sitting portion, and the plane defining the central semi-sitting portion is at an angle of about 25 to 60 degrees relative to a plane defining the forward leaning portion.
